(19) United States
(12) Patent Application Publication
(10) Pub. No.: US 2004/0194317 A1
(43) Pub. Date: Oct. 7, 2004

(54) Adjustable nut cracker

(76) Inventor: Aaron J. Pippert, Houston, TX (US)

Correspondence Address: Browning Bushman P.C., 5718 Westheimer, Suite 1800, Houston, TX, 77057, US

(21) Appl. No.: 10/760,330

(22) Filed: Jan. 20, 2004

Related U.S. Application Data
(60) Provisional application No. 60/442,675, filed on Jan. 27, 2003.

(51) Int. Cl. A47J 43/26

(52) U.S. Cl. 30/120.2

(57) ABSTRACT

An adjustable nut cracker includes two nut engagement members linked by a linking member. The linking member includes a slot having a plurality of wide slot portions interconnected by one or more narrow slot portions. The first nut engagement member is pivotally connected to the linking member by a pin passing through the slot. The pin includes a wide pin portion axially spaced from a narrow pin portion, and is axially movable to selectively position the wide pin portion or the narrow pin portion in the slot. A second nut engagement member is secured to the linking member and spaced apart from the first nut engagement member. The nut cracker is adjusted by laterally moving the narrow pin portion within the narrow slot portions to a selected wide slot portion, and thereafter axially moving the wide pin portion into the selected wide slot portion.

### BACKGROUND OF THE INVENTION

1. Field of the Invention

This invention relates to a nut cracker for applying a compressive force to crack nuts. More particularly, this invention relates to an adjustable nut cracker having an improved adjustment mechanism and combination of features for facilitating the cracking and shelling of nuts.

2. Related Art

A wide variety of nut crackers are known in the art. The majority of nut crackers are designed to be operable by hand for cracking individual nuts. Many have handles with adjustable spacing for accommodating nuts of varying size and shape. Examples of these are disclosed in U.S. Pat. Nos. 1,938,733 to Carlson, 2,989,103 to Walling, and 5,206,997 to Cunningham. Each of these disclose nut crackers having a pin and slot mechanism for varying the position of one handle with respect to another. One handle is carried on a pin which is received by a slot. The pin is movable within the slot to different positions, which accordingly provides a variable handle spacing for different nut sizes. Each of these prior art nut crackers, however, require a fairly complicated mechanism for spring-biasing the entire handle to retain the pin and handle in the different positions.

### SUMMARY OF THE INVENTION

An adjustable nut cracker is disclosed for applying a compressive force to crack a selected nut. In a preferred embodiment, the nut cracker includes first and second nut engagement members linked by a linking member. The linking member includes a slot having a plurality of wide slot portions interconnected by one or more narrow slot portions. The first nut engagement member is pivotally connected to the linking member by a first pin passing through the slot and the first nut engagement member. The first pin includes a wide pin portion axially spaced from a narrow pin portion, and is axially movable to selectively position the wide pin portion or the narrow pin portion in the slot. The narrow pin portion has a width less than a width of each narrow slot portion such that the narrow pin portion is movable within each narrow slot portion to a selected wide slot portion. The wide pin portion has a width greater than a width of each narrow slot portion and less than a width of each wide slot portions to prevent lateral movement of the pin when the wide pin portion is in the selected wide slot portion.

In a more preferred embodiment, a pin biasing member axially biases the pin, preferably such that the wide pin portion is biased toward the slot, so as to prevent the wide pin portion from inadvertently moving out of the wide slot portion when it is so positioned. The second nut engagement member is secured to the linking member and spaced apart from the first nut engagement member. Preferably, a second pin is used for this purpose, which, optionally, may allow the second nut engagement member to pivot.

In a particularly preferred embodiment, the first and second nut engagement members each include first and second nut gripping portions facing one another. Preferably, the nut gripping portions comprise a recess for receiving a portion of the selected nut. One or more radial projections may be disposed within each recess, each having a contact formation for contacting the selected nut when pivoting the first engagement member toward the second engagement member. In other embodiments, at least one of the nut gripping portions comprises a textured surface for increasing friction between the nut and the respective nut engagement member. For example, the textured surface may be a knurled surface known in the art.

Preferably, at least one of the first and second nut engagement members typically comprises a handle sized to fit in a hand. Alternatively, at least one of the first and second nut engagement members comprises a base for supporting the nut cracker while resting on a flat, substantially horizontal surface. The base may have a skid-resistant bottom surface.

One or both of the first or second nut engagement members may have a recess for at least partially receiving the linking member. When used, the recesses each have opposing recess side walls oriented substantially parallel to a face of the linking member through which the slot passes. A recess back wall bridges the recess side walls. The recess back wall may serve as a stop to limit pivoting of the engagement member with respect to the link. The first pin passes transversely through the opposing recess side walls. Thus, a depth of the recess may be selected to limit pivoting of the first or second nut engagement member. For example, the second nut engaging member may be permitted little to no pivotal movement.

This summary is intended to give a general idea of a preferred embodiment of the invention, without limiting the invention. The foregoing aspects of the invention will be more fully understood and better appreciated by reference to the following description and drawings.

### DESCRIPTION OF THE DRAWINGS

FIG. 1 is a perspective view of one embodiment of the nut cracker.

FIG. 2 is a bottom plan view taken along line 2-2 of FIG. 1.

FIG. 3 is an elevation view of a preferred embodiment of a linking member used in the nut cracker.

FIG. 4 is an elevation view of a pin with a biasing member used in the nut cracker.

FIG. 5 is a perspective view of another embodiment of the nut cracker.

### DETAILED DESCRIPTION OF THE PREFERRED EMBODIMENTS

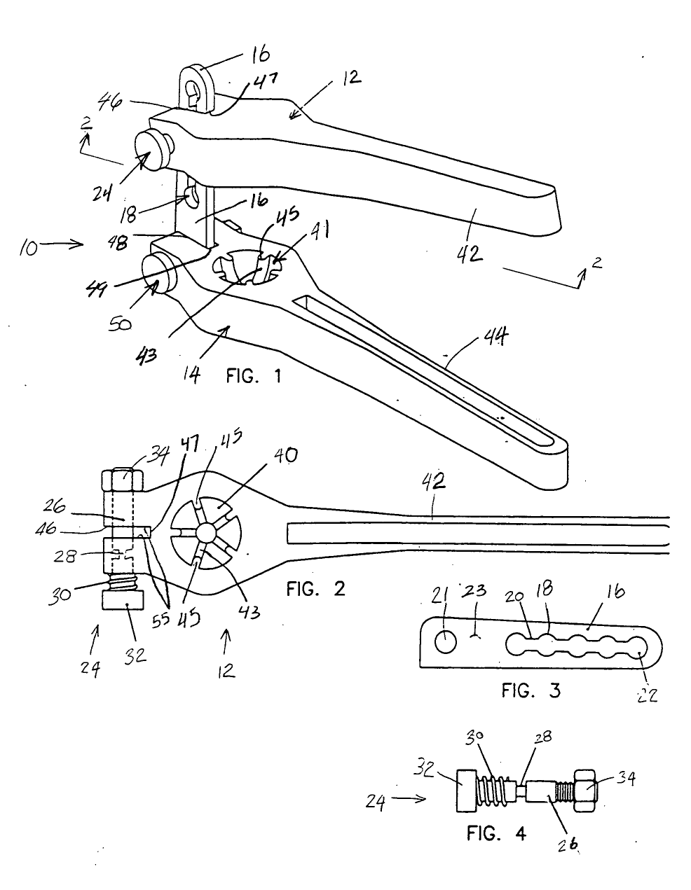

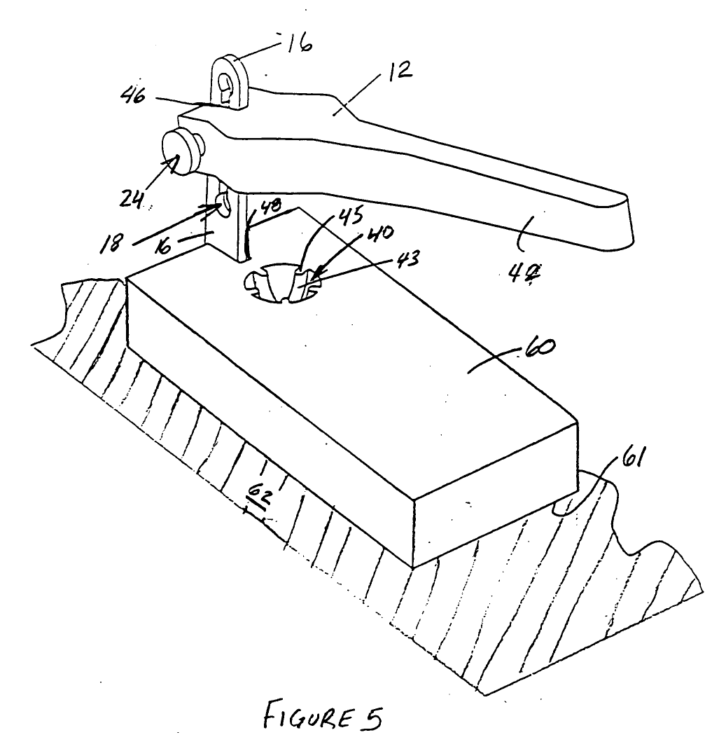

FIG. 1 shows a preferred embodiment of an adjustable nut cracker 10 for applying a compressive force to crack a selected nut. The nut cracker 10 includes a first nut engagement member 12 and a second nut engagement member 14. The nut engagement members 12, 14 have elongate members or handles 42, 44 each sized to fit in a hand. A rigid linking member 16 includes an opening or “slot” 22, shown more closely in FIG. 3. The slot 22 has a non-uniform width due to a plurality of wide slot portions 18 interconnected by one or more narrow slot portions 20. The wide slot portions 18 appear in the figure as circular holes, but may have other shapes in other embodiments. The first nut engagement member 12 is pivotally connected to the linking member 16 by a first pin 24 passing through the slot 16 and the first nut engagement member 12 for pivoting the first nut engagement member 12 toward the second nut engagement member 14. The first pin 24 includes a wide pin portion 26 axially spaced from a narrow pin portion 28. The first pin 24 is axially movable with respect to the slot 16 to selectively position the wide pin portion 26 or the narrow pin portion 28 in the slot 22. The narrow pin portion 28 has a width less than a width of each narrow slot portion 20 such that the narrow pin portion 28 is laterally movable within each narrow slot portion 20 to a selected wide slot portion 18. The wide pin portion 26 has a width greater than a width of each narrow slot portion 28 and less than a width of each wide slot portion 18, to prevent lateral movement of the pin 24 when the wide pin portion 26 is in the selected wide slot portion 18. The second nut engagement member 14 is secured to the linking member 16 by a bolt 50 and nut 51 and is spaced from the first nut engagement member 12.

The spacing between nut engagement members 12, 14 is adjustable for accommodating different sizes of nuts by axially positioning the narrow pin portion 28 in the slot 22 and laterally moving the pin 24 within the slot 22 to a selected one of the wide slot portions 18. The pivot point of the first nut engagement member 12 coinciding with the pin 24 may then be “locked” at the desired location by axially moving the first pin 24 to position the wide pin portion 26 within the selected wide slot portion 18. Preferably, a biasing member 30 is provided for axially biasing the pin 24 to retain the wide pin portion 26 within the selected wide slot portion 18. This minimizes the likelihood of accidental “unlocking” and repositioning of the first nut engagement member 12. As shown, the biasing member may be a coil spring 30. When it is desired to adjust the spacing between the first and second nut engagement members 12, 14, the pin 24 may be pressed in by thumb to axially move the pin 24 against the biasing force of the coil spring 24. A head 32 may be provided at the end of the first pin 24, to provide both a location for pressing the first pin 24 by thumb and to prevent removal of the first pin 24 from the first nut engagement member 12. While locked into position, the nut engagement member 12 is still free to pivot about the pin 24 so that a user may pivot the first nut engagement member 12 toward the second nut engagement member 14 to crack a nut positioned between nut engagement members 12, 14.

The second nut engagement member 14 may be secured to the linking member 16 with a second pin 50. The second pin 50 may allow the second nut engagement member 14 to pivot with respect to the linking member 16. In the embodiment of FIG. 1, the second pin 50 is spaced apart from the slot 22 and the first nut engagement member within the slot 22, such that the second nut engagement member 14 is free to pivot, but not move laterally with respect to the linking member 16. In less preferred embodiments (not shown) the second pin 50 may include the features of the first pin 24 and pass through the slot 22 and the second nut engagement member 14. Although generally unnecessary, this would allow the second nut engagement member 14 to move within the slot 16 to position the second pin 50 within its own selected wide slot portion 18.

In FIG. 1 each nut engagement member 12, 14 includes a respective recess 46, 48 for at least partially receiving the linking member 16. Each recess 46, 48 has opposing side walls (shown as side walls 55 in FIG. 2) oriented substantially parallel to a face 23 of the linking member through which the slot 22 passes, and a recess back wall 47, 49 bridging the recess side walls. The depth of the recesses 46, 48 and the depth of positioning of the linking member 16 within the recesses 46, 48 determines how far each nut engagement member 12, 14 may pivot before stopping against the linking member 16. Thus, the back walls 47, 49 may serve as stops to limit pivoting of the respective nut engagement members 46, 48. In some embodiments, pivoting of only one of the nut engagement members 12, 14 is desired, in which case the depth of one recess 46, 48 may be less than the other. For example, very little clearance may be provided between the linking member 16 and back wall 49, to limit pivoting of the second nut engagement member 14 such that substantially no pivoting is permitted, and a relatively greater degree of clearance may be provided between the linking member 16 and the back wall 47, to allow a relatively greater degree of pivoting of the first nut engagement member 12. As shown, the pins 24, 50 may pass transversely through the opposing recess side walls of the respective slots 46, 48.

In preferred embodiments, each nut engagement member 12, 14 includes a nut gripping portion 40, 41 to prevent a nut from slipping when the nut engagement members 12, 14 are squeezed together. The nut gripping portions 40, 41 may be depressions 40 and 41 as shown in FIGS. 1 and 2. Preferably, the nut gripping portions 40, 41 face toward each other and are positioned as close to the linking member 16 as possible, to maximize leverage for cracking the nut. The depressions 40, 41 are preferably sized and shaped to accommodate nuts having a variety of sizes and shapes. For example, the depressions 40, 41 are generally concave as shown and are deep and wide enough to accommodate a variety of nuts, but shallow enough so that there is a sufficient gap between nut engagement members 12, 14 to move the handles 42, 44 toward each other while cracking a nut. In other embodiments, at least one of the nut gripping portions 40 comprises a textured surface (not shown) such as a knurled surface known in the art for increasing friction between the nut and the respective nut engagement member 12, 14.

The depressions 40, 41 may also have one or more narrow projections 43 within each depression having contact formations 45 for contacting the selected nut. The projections 43 apply stress concentrations to the selected nut when cracking it, so that the nut preferentially cracks in the vicinity of the projections 43. This helps with shelling and cracking a nut, partly because the nut is not crushed inwardly across a large outer area, minimizing the damage to nut meat inside.

The pivoting action of the nut engagement members 12, 14 provides an additional advantage in aligning the respective nut gripping portions 40, 41. After the handle spacing has been adjusted as described above, and the nut engagement members 12, 14 have been pivoted outwardly to fit a nut therebetween, the nut gripping portions 40, 41 may be aligned by rocking the nut engagement members 12, 14 forward or backward with respect to one another. When the handles are then pivoted inward toward each other to crack the nut, each nut engagement portion 40, 41 will thus be better aligned with the nut.

In some embodiments the second nut engagement member 14 may comprise a base 60 shown in FIG. 5 for resting on a flat, substantially horizontal surface 62 such as a table top. A nut gripping portion such as the depression 40 may then be included on the base 60. The base 60 may be weighted and include a skid-resistant bottom surface 61 so that it does not easily slide when the nut engagement member 14 is forced downward to crack a nut. The base 60 supports the nut cracker 10 in a position that facilitates the cracking of nuts. As shown this position orients the first nut engagement member 12 and handle 42 for moving vertically to pivot about a horizontal axis. A user may, for example, position the nut cracker 10 on a table next to an armchair, and with the nut cracker 10 supported on the base 60, the user may crack a nut placed between recesses 40, 41 by applying a downward force on handle 42.

Although specific embodiments of the invention have been described herein in some detail, it is to be understood that this has been done solely for the purposes of describing the various aspects of the invention, and this is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from the spirit and scope of the invention.

What is claimed is:

1. An adjustable nut cracker for applying a compressive force to crack a selected nut, comprising:
first and second nut engagement members;
a linking member including a slot having a plurality of wide slot portions interconnected by one or more narrow slot portions;
a first pin, the first nut engagement member being pivotally connected to the linking member by the first pin passing through the slot and the first nut engagement member, the first pin including a wide pin portion axially spaced from a narrow pin portion, the first pin being axially movable to selectively position the wide pin portion or the narrow pin portion in the slot, the narrow pin portion having a width less than a width of each narrow slot portion such that the narrow pin portion is movable within each narrow slot portion to a selected wide slot portion, the wide pin portion having a width greater than a width of each narrow slot portion and less than a width of each wide slot portion to prevent lateral movement of the pin when the wide pin portion is in the selected wide slot portion; and
the second nut engagement member being secured to the linking member and spaced apart from the first nut engagement member.

2. An adjustable nut cracker as defined in claim 1, further comprising:
a pin biasing member for axially biasing the first pin to urge the wide pin portion toward the slot.

3. An adjustable nut cracker as defined in claim 2, wherein the biasing member is a coil spring.

4. An adjustable nut cracker as defined in claim 1, further comprising:
a second pin for securing the second nut engagement member to the linking member.

5. An adjustable nut cracker as defined in claim 4, wherein the second pin pivotally secures the second nut engagement member to the linking member.

6. An adjustable nut cracker as defined in claim 4, wherein the second pin fixedly secures the second nut engagement member to the linking member such that the second nut engagement member is not pivotable with respect to the linking member.

7. An adjustable nut cracker as defined in claim 1, further comprising:
first and second nut gripping portions on each of the first and second nut engagement members, respectively, the nut gripping portions facing one another.

8. An adjustable nut cracker as defined in claim 7, wherein at least one of the nut gripping portions comprises a depression for receiving a portion of the selected nut.

9. An adjustable nut cracker as defined in claim 8, further comprising:
one or more lateral projections within each depression, each lateral projection having a contact formation for contacting the selected nut when pivoting the first engagement member toward the second engagement member.

10. An adjustable nut cracker as defined in claim 1, wherein at least one of the first and second nut engagement members comprises a handle sized to fit in a hand.

11. An adjustable nut cracker as defined in claim 1, wherein at least one of the first and second nut engagement members comprises a base for supporting the nut cracker while resting on a flat, substantially horizontal surface.

12. An adjustable nut cracker as defined in claim 11, wherein the base further comprises a skid-resistant bottom surface.

13. An adjustable nut cracker as defined in claim 1, wherein the first or second nut engagement member further comprises:
a recess for at least partially receiving the linking member, the recess having opposing recess side walls oriented substantially parallel to a face of the linking member through which the slot passes and a recess back wall bridging the recess side walls.

14. An adjustable nut cracker as defined in claim 13, wherein the first nut engagement member includes the recess, and the first pin passes transversely through the opposing recess side walls.

15. An adjustable nut cracker as defined in claim 13, wherein the back wall provides a stop for limiting pivoting of the respective nut engagement member.

16. An adjustable nut cracker as defined in claim 13, wherein each of the first and second nut engagement members includes a recess for at least partially receiving the linking member, each recess having opposing recess side walls oriented substantially parallel to a face of the linking member through which the slot passes and a recess back wall bridging the recess side walls.

17. An adjustable nut cracker for applying a compressive force to crack a selected nut, comprising:
a linking member including a slot having a plurality of wide slot portions interconnected by one or more narrow slot portions;
first and second nut engagement members, each of the first and second nut engagement members including a recess for at least partially receiving the linking member, each recess having opposing recess side walls oriented substantially parallel to a face of the linking member through which the slot passes and a recess back wall bridging the recess side walls, the back wall providing a stop for limiting pivoting of the respective nut engagement member;
a first pin, the first nut engagement member being pivotally connected to the linking member by the first pin passing through the slot and the first nut engagement member, the first pin including a wide pin portion axially spaced from a narrow pin portion, the first pin being axially movable to selectively position the wide pin portion or the narrow pin portion in the slot, the narrow pin portion having a width less than a width of each narrow slot portion such that the narrow pin portion is movable within each narrow slot portion to a selected wide slot portion, the wide pin portion having a width greater than a width of each narrow slot portion and less than a width of each wide slot portion to prevent lateral movement of the pin when the wide pin portion is in the selected wide slot portion;
a spring for axially biasing the first pin to urge the wide pin portion toward the slot;
the second nut engagement member being secured to the linking member with a second pin and spaced apart from the first nut engagement member; and
first and second nut gripping portions on each of the first and second nut engagement members, respectively, the nut gripping portions facing one another.

18. An adjustable nut cracker as defined in claim 17, wherein the second pin pivotally secures the second nut engagement member to the linking member.

19. An adjustable nut cracker as defined in claim 17, wherein the second pin fixedly secures the second nut engagement member to the linking member such that the second nut engagement member is not pivotable with respect to the linking member.

20. An adjustable nut cracker as defined in claim 17, wherein at least one of the nut gripping portions comprises a depression for receiving a portion of the selected nut

21. An adjustable nut cracker as defined in claim 20, further comprising:
one or more lateral projections within each depression, each lateral projection having a contact formation for contacting the selected nut

22. An adjustable nut cracker as defined in claim 17, wherein at least one of the first and second nut engagement members comprises a handle sized to fit in a hand.

23. An adjustable nut cracker as defined in claim 17, wherein at least one of the first and second nut engagement members comprises a base for supporting the nut cracker while resting on a flat, substantially horizontal surface.
